(19) United States
(12) Patent Application Publication
(10) Pub. No.: US 2008/0019884 A1
(43) Pub. Date: Jan. 24, 2008

(54) Apparatus for Producing Hydrogen

(75) Inventors: Nicolas Zartenar, Holzkirchen (DE); Peter Britz, Egmating (DE); Klaus Wanninger, Kolbermoor (DE); Anja Wick, Dortmund (DE)

Correspondence Address: THE WEBB LAW FIRM, P.C., 700 KOPPERS BUILDING, 436 SEVENTH AVENUE, PITTSBURGH, PA, 15219, US

(73) Assignees: Viessmann Werke GBBH & Co. KG, Allendorf (DE); Sued-Chemie AG, Muenchen (DE)

(21) Appl. No.: 10/581,582

(22) PCT Filed: Nov. 25, 2004
(86) PCT No.: PCT/DE04/02608

§ 371 Date: Aug. 23, 2007

(30) Foreign Application Priority Data
Dec. 2, 2003 (DE) 10356650.3

(51) Int. Cl. C01B 3/58; B01J 12/00; B01J 19/24; C01B 3/38; C01B 3/48

(52) U.S. Cl. 422/192; 422/190

(57) ABSTRACT

The invention relates to an apparatus for producing hydrogen. Said apparatus comprises a reformer stage for converting hydrocarbon gas and water to hydrogen and other reformed products. At least one of the catalyst stages mounted downstream of the reformer stage is provided for the catalytic conversion of the reformed products. The apparatus also comprises a methanation stage which is mounted downstream of the catalyst stage and through which the medium flows in an axial direction. A flow guidance housing for a coolant extends in the axial direction of flow and is associated with said methanation stage. According to the invention, the flow guidance housing comprises at least two, preferably three or more cooling zones which have different cooling effects and which are disposed one after the other in the axial direction.

The present invention relates to an apparatus for producing hydrogen according to the preamble of claim 1.

An apparatus of the type cited at the beginning is described in the previously published DE 202 11 546 U1 and the subsequently published DE 102 40 953 A1 and EP 1 415 705 A1. This apparatus comprises, inter alia, a steam reformer stage, preferably heatable using a burner, for converting hydrocarbon gas and water into hydrogen and further reformer products such as carbon dioxide and carbon monoxide. For example, a PEM fuel cell may be operated using the hydrogen produced. Since the reformate still contains a comparatively large amount of carbon monoxide after the reformer stage (fuel-cell poison), a catalyst stage is connected downstream therefrom, in order to catalytically convert the carbon monoxide into carbon dioxide (unproblematic for the fuel cell). For ultrapurification, i.e., to reduce the carbon monoxide content in the reformate even further, finally a methanization stage is connected downstream from the catalyst stage, which converts the remaining carbon monoxide (back) into methane gas using hydrogen. The entry temperature of the reformate gas containing the carbon monoxide into the methanization stage is typically approximately 240° C. in this case. Since the methanization process proceeds exothermically, cooling of the methanization stage is necessary. For this purpose, a flow guiding housing for a coolant is provided, which is assigned to the stage alternately externally or from the interior (for hollow-cylindrical implementation, for example), depending on the implementation of the methanization stage. This flow guiding housing may have the coolant flow through it in parallel flow or counterflow to the reformate flow as needed.

Experiments have now shown that the reformate gas at the outlet of the methanization stage, in spite of the cooling described using a coolant guided through the flow guiding housing, has an unexpectedly high carbon monoxide content (100 ppm and more), which is unacceptable, since the carbon monoxide—as noted—is harmful to the fuel cell. The cause for this high carbon monoxide content is apparently a retroshift reaction, in which the hydrogen just produced reacts with the reformer product carbon dioxide and forms carbon monoxide and water. This reaction is undesired because of the consumption of the hydrogen just produced, and in addition because of the harmful effect of the carbon monoxide on the fuel cell mentioned.

The present invention is accordingly based on the object of ensuring in the simplest possible way, in an apparatus of the type cited at the beginning, that this retroshift reaction does not occur and the carbon monoxide component in the reformate gas at the outlet of the methanization stage is as low as possible, preferably significantly less than 100 ppm.

This object is achieved with an apparatus of the type cited in the beginning by the features listed in the characterizing part of claim 1.

It is accordingly provided according to the present invention that the flow guiding housing has at least two, preferably three or more cooling zones having different cooling effects situated one behind another in the axial direction. The use of at least two cooling zones results in a stepped or continuously changing temperature curve within the methanization stage—depending on the constructive implementation of the cooling zones—which in turn results, with corresponding coolant temperature, in the temperature being reduced significantly toward the exit of the methanization stage in spite of the exothermic methanization process and the undesired retroshift reaction accordingly not occurring. The special advantage of the present invention is thus that the temperature curve within the methanization stage may be influenced in a targeted way and a minimal carbon monoxide content in the reformate gas may be achieved in this way.

Thanks to the achievement of the object according to the present invention, an “air bleed” may also be dispensed with in this case, which until now was connected downstream from the methanization stage and upstream from the fuel cell, and in which the residual carbon monoxide contained in the reformate was oxidized using small quantities of oxygen.

For the sake of completeness, reference is additionally made to U.S. Pat. No. 3,441,393 A, from which a method for producing a hydrogen-rich gas is known. In this facility, a “commercially available” methanization stage is provided, i. e., not a gas ultrapurification stage having the multizone cooling according to the present invention. With this achievement of the object, the reformate gas enters the methanization reactor at 316° C. and leaves it at 379° C., i. e., even heated by 63° C. The recognition according to the present invention of cooling the methanization stage in multiple stages in order to prevent a retroshift reaction cannot be inferred from this publication.

Other advantageous refinements of the present invention result from the dependent claims.

The apparatus according to the present invention, including its advantageous refinements, is explained in greater detail in the following on the basis of the drawing of different exemplary embodiments using multiple diagrams.

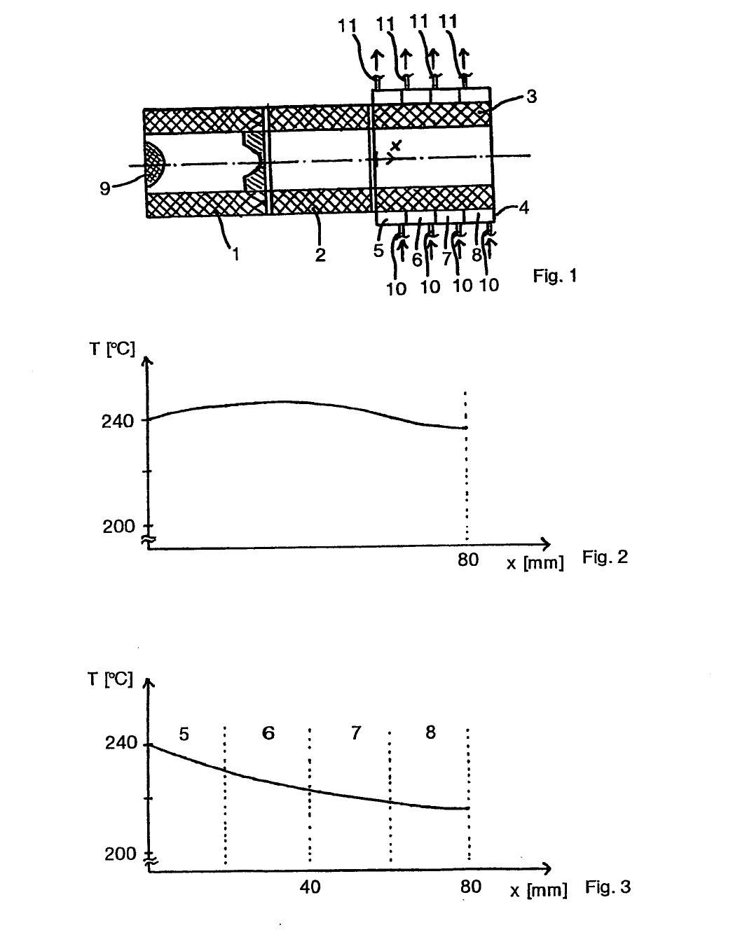

FIG. 1 schematically shows the apparatus according to the present invention having a methanization stage having four cooling zones in section;

FIG. 2 shows the temperature curve as a diagram plotted over the run length x within the methanization stage when one cooling zone is used (related art);

FIG. 3 shows the temperature curve as a diagram plotted over the run length x within the methanization stage when four cooling zones are used;

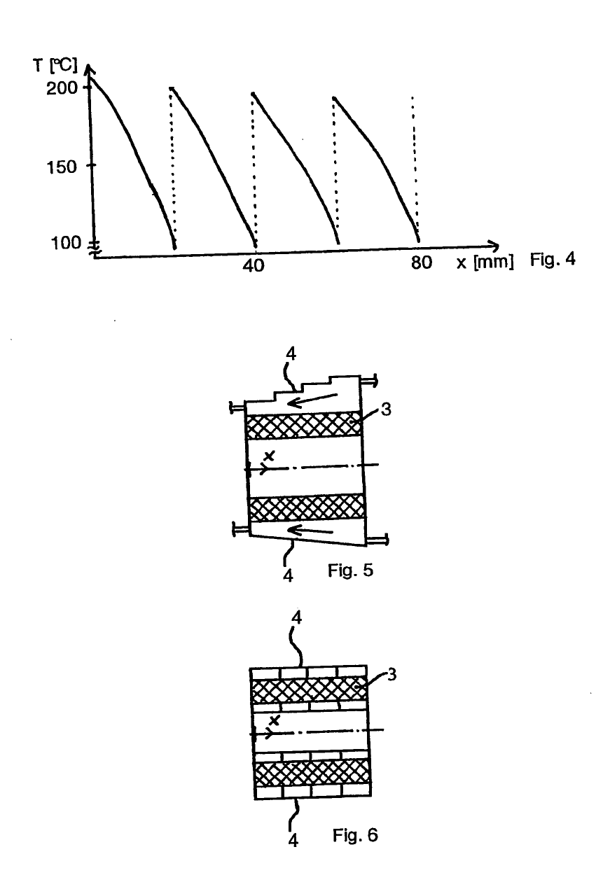

FIG. 4 shows the temperature curve as a diagram plotted over the run length x within the four cooling zones;

FIG. 5 schematically shows two further embodiments of the flow guiding housing on the methanization stage in section (summarized in one illustration for the sake of simplicity); and

FIG. 6 schematically shows a further embodiment of the flow guiding housing on the methanization stage in section.

FIG. 1 schematically shows the apparatus according to the present invention for producing hydrogen in section.

This comprises a reformer stage 1 for converting hydrocarbon gas and water into hydrogen and further reformer products. The reformer stage 1, which has a reformer catalyst, is preferably implemented, as shown, as a steam reformer stage heated using a burner 9, in particular a gas burner, i.e., in this stage, for example, CH₄ and H₂O are converted into CO, CO₂, and H₂ while heat is supplied (by the burner 9) (endothermic reaction). In order to ensure the most uniform possible temperature curve within the reformer stage 1 and thus optimum hydrogen production, the reformer stage 1 is preferably implemented as a hollow cylinder, as shown.

Furthermore, the apparatus according to the present invention comprises at least one catalyst stage 2, connected downstream from the reformer stage 1, for catalytic conversion of the carbon monoxide, i. e., this is at least partially converted into carbon dioxide, which is harmless to the fuel cell. As in the reformer stage 1, the catalyst stage 2 is advantageously also implemented as a hollow cylinder. This measure results in a more uniform temperature curve and thus in better carbon monoxide conversion within the catalyst stage 2.

Finally, the apparatus according to the present invention comprises a methanization stage 3 connected downstream from the catalyst stage 2, which has axial flow through it and which, as noted, is used for the purpose of methanizing as much as possible of the residual carbon monoxide contained in the reformate gas using hydrogen. For temperature control of the methanization stage 3, a flow guiding housing 4 for a coolant, which extends in the axial flow direction, is assigned thereto. The methanization stage 3 is preferably also implemented as a hollow cylinder, as shown.

In order to ensure flow through the individual stages of the apparatus according to the present invention which is as free of pressure loss as possible, it is also advantageously provided that the reformer stage 1, the catalyst stage 2, and the methanization stage 3 are situated one after another in the axial flow direction. With a hollow-cylindrical implementation, is also advantageous for the stages to be situated one after another defining a continuous annular chamber in the axial flow direction.

It is essential for the apparatus according to the present invention for producing hydrogen that the flow guiding housing 4 has at least two, preferably three or more cooling zones 5, 6, 7, 8 having different cooling effects situated one after another in the axial direction.

In the embodiment shown in FIG. 1, the flow guiding housing 4 is divided into four cooling zones 5, 6, 7, 8, to each of which the coolant may be supplied separately. In principle, however, two zones are already capable of achieving the object defined at the beginning. The more cooling zones are provided, the more precisely may the temperature curve within the methanization stage be fixed, but the outlay for apparatus also becomes greater. Four zones have been shown to be a favorable selection here.

With a hollow-cylindrical implementation of the methanization stage 3, it has also been shown to be advantageous for the cooling zones 5, 6, 7, 8 to be situated alternately inside and/or outside the methanization stage 3 (see FIG. 6). In this case, the cooling zones 5, 6, 7, 8 preferably enclose the methanization stage 3 like annular chambers situated axially one after another or, with a hollow-cylindrical implementation of the methanization stage 3, are enclosed thereby (see FIG. 6 again).

As schematically shown in FIG. 1, it is also advantageous for each cooling zone 5, 6, 7, 8 to have at least one coolant supply connection 10 and one coolant removal connection 11, each cooling zone 5, 6, 7, 8 additionally advantageously being able to have coolant flow through it alternately in parallel flow (not shown) or in counterflow to the methanization stage 3.

In order to also implement optimum cooling which is adapted to the requirements, it is advantageous for different coolants to be supplied to the cooling zones 5, 6, 7, 8.

Furthermore, it is advantageous for a coolant which is used to be supplied alternately at different temperatures to the individual zones 5, 6, 7, 8 or, if different coolants are used, for these to have different temperatures, for example, by using heat exchangers (not shown).

FIG. 2 shows a temperature curve over the run length x (see FIG. 1) within a methanization stage, which only has one cooling zone (related art). As noted, carbon monoxide and hydrogen is converted back into hydrocarbon gas (methane) in the methanization stage in order to reduce the carbon monoxide component in the reformate gas. Since the methanization is an exothermic procedure, the temperature first rises in the stage and then falls because of the cooling to a value just below the entry temperature. With a construction of this type, the carbon monoxide content is typically approximately 120 ppm, i.e., too much to conduct the reformate gas directly to the fuel cell. As noted, an “air bleed” is therefore typically connected downstream from the methanization stage in order to also remove this component of carbon monoxide.

The cause for the still comparatively high carbon monoxide component in the reformate gas after the methanization stage has been shown to be that retroshift reactions, in which carbon dioxide and hydrogen react to form carbon monoxide and water, occur again and again because of the quite high temperatures at the outlet of the stage.

According to the present invention, as described, the methanization stage is divided into multiple cooling zones in order to lower the temperature toward the outlet of the stage in a targeted way so that the undesired retroshift reactions no longer occur. A corresponding temperature curve is shown in FIG. 3, which may be implemented if the cooling zone distribution according to the present invention is used. The temperature in the methanization stage thus falls with this achievement of the object continuously from 240° C. to approximately 220° C., with the result that, in particular at the end of the methanization stage, retroshift reactions may no longer occur, since the temperatures are too low for this purpose in the area of this cooling zone. The reference numbers 5, 6, 7, 8 and the dotted lines in FIG. 3 are to illustrate the area where the cooling zones are situated.

FIG. 4 illustrates the temperature curve within the individual cooling zones. It is particularly noticeable that because of the cooling in counterflow, a type of sawtooth profile arises, but the temperature peaks always fall again toward the outlet of the stage, from which the desired, falling temperature curve within the methanization stage may necessarily be concluded.

According to the two further embodiments of the flow guiding housing 4 of the methanization stage illustrated in FIG. 5, it is provided as alternative to the achievement of the object shown in FIG. 1 that the cooling zones 5, 6, 7, 8 situated one behind another in the axial direction are directly hydraulically connected to one another, but have different flow cross-sections. According to the present invention, a direct hydraulic separation of the cooling zones 5, 6, 7, 8 is not required, rather the heat transmission in the individual areas of the methanization stage may also be influenced in a targeted way through suitable selection of the axial flow cross-sections. In this case, a large flow cross-section means a low flow speed and therefore relatively poor heat transmission, or a small cross-section means a high flow speed and therefore quite good heat transmission; all also as a function of temperature gradient between coolant and methanization stage, of course.

Finally, it is advantageously provided according to the upper illustration in FIG. 5 that the cooling zones 5, 6, 7, 8 have stepped flow cross-sections to one another in the axial direction. Alternatively (lower illustration) continuously changing flow cross-sections are also provided, in both cases the cooling zones 5, 6, 7, 8 alternately being able to have coolant flow through them in parallel flow or counterflow to the methanization stage 3.

### List of Reference Numbers

1 reformer stage
2 catalyst stage
3 methanization stage
4 flow guiding housing
5 cooling zone
6 cooling zone
7 cooling zone
8 cooling zone
9 burner
10 coolant supply connection
11 coolant removal connection

1-10. (canceled)

11. An apparatus for producing hydrogen, comprising
a) a reformer stage for converting hydrocarbon gas and water into hydrogen and at least one further reformer product,
b) at least one catalyst stage, connected downstream from the reformer stage, for catalytic conversion of the at least one further reformer product arising during the reforming process,
c) a methanization stage, which is connected downstream from the catalyst stage and has axial flow, to which a flow guiding housing for a coolant extending in the axial flow direction is assigned,
wherein the flow guiding housing has at least two cooling zones having different cooling effects situated one behind another in an axial direction.

12. The apparatus for producing hydrogen according to claim 11, wherein the coolant is supplied separately to each of the cooling zones.

13. The apparatus for producing hydrogen according to claim 12, wherein the cooling zones enclose the methanization stage as annular chambers situated one after another or, with a hollow-cylindrical implementation of the methanization stage, are enclosed thereby.

14. The apparatus for producing hydrogen according to claim 12, wherein each cooling zone has at least one coolant supply connection and one coolant removal connection.

15. The apparatus for producing hydrogen according to claim 12, wherein each cooling zone may have coolant flow through it alternately in parallel flow or counterflow to the methanization stage.

16. The apparatus for producing hydrogen according to claim 12, wherein different coolants are supplied to the cooling zones.

17. The apparatus for producing hydrogen according to claim 11, wherein the cooling zones situated one behind another in the axial direction are directly hydraulically connected to one another, and have different flow cross-sections, the cooling zones alternately having at least one of stepped flow cross-sections and continuously changing flow cross-sections in the axial direction and the cooling zones are adapted to have coolant flow through them alternately in parallel flow or counterflow to the methanization stage.

18. The apparatus for producing hydrogen according to claim 11, wherein at least one of the reformer stage, the catalyst stage, and the methanization stage are implemented as hollow cylinders.

19. The apparatus for producing hydrogen according to claim 18, wherein at least one of the reformer stage, the catalyst stage, and the methanization stage are situated one behind another to define a continuous annular chamber in the axial flow direction.

20. The apparatus for producing hydrogen according to claim 18, wherein the cooling zones, if the methanization stage is implemented as a hollow cylinder, are alternately situated inside and/or outside the methanization stage.

21. The apparatus for producing hydrogen according to claim 11, wherein the at least one reformer product is carbon dioxide, carbon monoxide or any combination thereof.

22. The apparatus for producing hydrogen according to claim 11, wherein the flow guide housing has three or more cooling zones.

23. The apparatus for producing hydrogen according to claim 16, wherein the different coolants are temperature controlled differently.
